(19) United States
(12) Patent Application Publication
(10) Pub. No.: US 2010/0145866 A1
(43) Pub. Date: Jun. 10, 2010

(54) METHOD AND SYSTEM FOR FINALIZING SPECIFIC PROCESSES THROUGH A DYNAMIC SYSTEM

(76) Inventor: Aaron A. Romano, Henderson, NV (US)

Correspondence Address: HOLLAND & HART LLP, 60 E. South Temple, Suite 2000, P.O. Box 11583, Salt Lake City, UT, 84110, US

(21) Appl. No.: 12/614,221

(22) Filed: Nov. 6, 2009

Related U.S. Application Data
(63) Continuation of application No. 10/194,427, filed on Jul. 12, 2002, now abandoned.

(51) Int. Cl. G06F 15/16; G06Q 50/00; G06F 17/30; G06Q 10/00

(52) U.S. Cl. 705/316; 707/802; 709/203; 707/E17.044

(57) ABSTRACT

A method and system for assisting and/or completing a complex transaction process, such as those relating to a real estate transaction. The method or system is implemented over a computer network. The method or system allows selection of a particular business sector and/or jurisdiction for completing a transaction and provides the appropriate documents for the selected business sector and/or jurisdiction. The method and system further provides for completing and electronically delivering the completed documents to a user.

### RELATED APPLICATIONS

This application is a continuation of and claims priority to U.S. application Ser. No. 10/194,427 filed 12 Jul. 2002 and titled METHOD AND SYSTEM FOR FINALIZING SPECIFIC PROCESSES THROUGH A DYNAMIC SYSTEM.

### TECHNICAL FIELD

The present invention is generally directed to a method and system for assisting in the completion of a complex transaction process; and more particularly to a method and system for providing the required documentation for completing a transaction process, potentially in various business sectors and/or wherein the transaction process may be completed in one of a plurality of different jurisdictions.

### BACKGROUND OF THE INVENTION

In order for many transactions to be finalized, multiple documents must be completed and submitted to various entities, such as governmental agencies, private institutions and individuals. Typically these documents are completed as representatives for each agency, institution or individual (all of which may have varying requirements and interests) interact at various points along the transaction. To correctly complete the transaction, individuals, professionals, institutions and governmental agencies must coordinate efforts in some manner to ensure the proper documentation is accurate, complete and properly finalized. Unfortunately, the process often breaks down and costs increase as documents and/or the content within the documents are created by and transferred from one party to another.

Additionally, the required documents and the content necessary for the completion of such documents may differ from business sector to business sector and/or jurisdiction to jurisdiction, often compounding and increasing errors, time and costs. In multi jurisdictional transactions or simply a transaction in a business sector and/or jurisdiction other than a professional's designated or licensed area, the individuals must find, verify and contact a professional in the other sector and/or jurisdiction(s) in order to complete the transaction. Such a process may increase the time and cost involved to finalize a deal to the point that thousands of dollars are lost and the often limited and sensitive time constraints cause the entire transaction to fail.

For example, in the real estate industry, the filing of a deed of trust in one jurisdiction may require multiple pages and supporting documentation that is approved by one or more of the following professionals: (a) real estate agent for the buyer, (b) real estate agent for the seller, (c) mortgage lending institutions, (d) an attorney licensed in the particular jurisdiction, (e) escrow agent, (f) the buyer's or seller's banking institutions, and (g) the recording office personnel of the state or local government. In a different jurisdiction, the documents associated with a deed of trust or equivalent in the jurisdiction may be completely different. The current system requires individuals to expend a significant amount of time and costs finding, verifying and interacting with each of the professionals in various jurisdictions, just to file the proper document with the proper governmental agency.

As such, it would be advantageous to provide a system whereby end-users, whether professionals or individuals, could more efficiently and effectively select, review and complete the necessary processes in any particular business sector and/or jurisdiction, including, without limitation, capturing the necessary content to complete the necessary documentation in the particular sector and/or jurisdiction.

### SUMMARY OF THE INVENTION

The present invention relates to a computer or computer network implemented method and system for enabling the creation of documents for executing a transaction process for completing a complex transaction. The particular transaction process needed to complete the transaction at issue, can be customized for a particular business sector and/or jurisdiction. This is beneficial for those transaction processes that vary from business sector to business sector and/or jurisdiction to jurisdiction for a particular type of transaction (e.g., real estate closings).

The system provides a web site or other location accessible by a computer network (while the preferred system is embodied in a web site or a dedicated network of computers, it is possible to provide the functionality described herein for placement via a CD or other computer readable medium, onto a single non-networked computer) that is linked to a database having the required documents to complete the complex transaction process. For those transactions that have processes that differ from business sector to business sector and/or jurisdiction to jurisdiction, the system includes the required documents for a variety of different business sectors and/or jurisdictions. That is, the specific documents required for each different business sector and/or jurisdiction are stored in the database. Additionally, the database may have multiple transaction processes available for each business sector and/or jurisdiction, or instead, may be dedicated to one type of transaction process (again, e.g., real estate closings) for each business sector and/or jurisdiction.

The web site interactively obtains the information relevant to complete the documents for the particular transaction process at issue for a selected business sector and/or jurisdiction (if more than one is available). The web site can then, using the obtained relevant information, prepare the required documents for completing the transaction process. These documents can be electronically delivered to the user of the system. The web site can also coordinate calendaring of events to complete the transaction, and may notify the user ahead of such dates. Additionally, the site can obtain information from the user whenever a particular task is completed to maintain and track the status of the transaction.

In one embodiment, the invention comprises a method for online completion of a complex transaction comprising the steps of providing at least one server computer in communication with a computer network, generating output from the server computer identifying at least one transaction process and, receiving input by the server computer selecting a particular transaction process for use in the transaction (for instances where only one transaction process available, the selecting step can be any act initiating the transaction process). The input is from a user of the system incorporating the server computer.

The method may also include receiving input by the server computer identifying a business sector and/or jurisdiction for the transaction. The server computer can be configured to assist completion of a number of different complex transaction processes (i.e., generating output from the server computer identifying a plurality of transaction processes), or instead, can be dedicated to one type of transaction process (e.g., real estate closings). In the latter case, the at least one transaction process would always be the particular transaction selected by the user.

The method may further comprise the step of receiving input by the server computer information relevant to the particular transaction process. The information may include, for example, identification of a plurality of entities involved in the transaction. This receiving step may be part of an interactive process wherein a user provides information in response to questions posed by the server computer. The server computer can then determine if the inputted information relevant to the particular transaction process is sufficient, and if not, generate output identifying missing information required for the particular transaction process.

In connection with obtaining information relevant to the particular transaction process, the method may include generating output from the server identifying required documents for completing the transaction (in the identified business sector and/or jurisdiction if more than one business sector and/or jurisdiction is available). The server computer may include a resident database of electronically stored documents in a variety of formats, or may be linked to one or more other computers containing such documents. Notwithstanding where the documents are located, the method further includes the server computer incorporating the information relevant to the particular transaction process into the required documents, and electronically delivering to the user the required documents incorporating the information relevant to the particular transaction process.

In addition to completing the documentation relating to the transaction process, the method may also include generating output from the server identifying tasks required to complete the transaction. Such tasks may include, for example, obtaining appropriate signatures on various documents or recording or filing various documents with various government agencies or other entities.

For situations where the user desires to revise or update the information provided, the method may include receiving input by the server computer of revised information relevant to the particular transaction process, incorporating the revised information relevant to the particular transaction process into the required documents, and, electronically delivering from the server to the user the required documents incorporating the revised information relevant to the particular transaction process.

The method may also include calendaring dates by the server of events necessary for the completion of the particular transaction process; and, generating output from the server electronically notifying a user of the dates of the events prior to the dates of the events. Moreover, the server computer can receive input from the user relating to the completion of various tasks to monitor or track the process.

One transaction process that may be implement with the method is for a real estate transaction. After selecting the appropriate business sector (from a list including e.g., real estate closings, deeds, medical transactions etc.) and/or jurisdiction (e.g., State, County etc.), the method would then include generating output from the server computer identifying documents required in the selected business sector and/or jurisdiction for closing the transaction. The system would then interact with the user to obtain the required information for completing the particular required documents and generate a completed set of documents incorporating such information.

In another embodiment a system for online completion of a complex transaction comprises at least one server computer having an interface for communication over a computer network wherein the server computer is configured to generate information through the interface identifying at least one transaction process (and in some instances, a plurality of available transaction processes). Additionally, the server computer is configured to receive information through the interface selecting a particular transaction process for use in the transaction, and for transaction processes that differ from business sector to business sector and/or jurisdiction to jurisdiction, to receive information through the interface identifying a business sector and/or jurisdiction for the transaction. The server computer is further configured to receive information relevant to the particular transaction process, and determine if the received information relevant to the particular transaction process is sufficient. If not, the system generates a message identifying the missing information required for the particular transaction process.

Once it has the relevant information, the server computer is configured to incorporate the information relevant to the particular transaction process into the required documents, and to deliver the required documents incorporating the information relevant to the particular transaction process through the interface to a user. The server computer can also be configured to generate information identifying tasks related to completing the transaction, and can further be configured to calendar and notify the user of particular dates associated with completion of the process.

The server can be further configured to receive input of revised information relevant to the particular transaction process; incorporate the revised information relevant to the particular transaction process into the required documents; and, electronically deliver to the user the required documents incorporating the revised information relevant to the particular transaction process.

In another embodiment, a computer program product for use with a computer comprises a computer usable medium having computer readable program code embodied therein, the program code including a first portion for receiving information identifying a plurality of entities involved in a transaction; a second portion for generating information identifying at least one transaction process available for the transaction; a third portion for receiving information selecting a particular transaction process for use in the transaction; and, a fourth portion for receiving information relevant to the particular transaction process. The computer usable medium can be, for example, a CD, DVD, floppy disc or the hard drive of a computer. The program code may include a portion for receiving information identifying a business sector and/or jurisdiction for the transaction and a portion for generating information identifying at least one transaction process available for the identified business sector and/or jurisdiction (or in some instances, a plurality of transaction processes).

The program code may further comprises a portion for receiving information relevant to the particular transaction process, and another portion for determining if the received information relevant to the particular transaction process is sufficient. If not sufficient, the program code may include a portion for identifying missing information required for the particular transaction process.

The computer program product further comprises a portion for identifying required documents maintained in a database for completing the transaction in the identified business sector and/or jurisdiction, another portion for incorporating the information relevant to the particular transaction process into the required documents, and yet another portion for electronically delivering to a user the required documents incorporating the information relevant to the particular transaction process.

The computer program product may further comprising a portion for calendaring dates of events necessary for the completion of the particular transaction process; and, a portion for notifying a user of the dates of the events prior to the dates of the events. The program may also include code for tracking a status of the particular transaction process.

In addition to the features described above, the computer program product can include any of the other functionality described in this Application. Conventional programming code can be utilized to implement the functional applications described.

In yet another embodiment, a method for providing forms for an online completion of a complex transaction comprising the steps of providing a web site hosted by at least one computer in communication with a computer network; providing at the web site identification of a plurality of business sectors and/or jurisdictions available for selection by a user of the web site; providing at the web site identification of at least one transaction process available in each of the plurality of business sectors andor jurisdictions for selection by the user; and, communicating with a database based on a link defined by the web site, said database including a plurality of electronically stored forms relating to a plurality of transaction processes. The method further comprises the steps of receiving from the user of the web site a selection of a particular business sector and/or jurisdiction; receiving from the user of the web site a selection of a particular transaction process available in the selected business sector and/or jurisdiction; and providing at the web site an identification of required documents for completion of the selected transaction process in the selected business sector and/or jurisdiction. For those instances concerned with only one business sector and/or jurisdiction, the method can simply comprise providing at the web site identification of at least one transaction process available for selection by a user, and communicating with a database based on a link defined by the web site, said database including a plurality of electronically stored forms relating to a selected transaction process.

The method further comprises the steps of receiving from the user of the web site information relevant to the selected transaction process; and, incorporating the information received from the user of the web site into the required documents. The method further includes electronically delivering to the user of the web site the required documents incorporating the information relevant to the selected transaction process.

If the information needs to be corrected or updated, the method may further comprise the steps of receiving from the user of the web site revised information relevant to the selected transaction process; incorporating the revised information relevant to the selected transaction process received from the user of the web site; and, electronically delivering to the user of the web site the required documents incorporating the revised information relevant to the selected transaction process.

In addition to creating and delivering the appropriate documents, the method may further comprising the step of providing the user of the web site with identification of any tasks associated with completing the selected transaction process. It may also include identifying dates on the web site relating to completion of the selected transaction process and electronically notifying the user of the web site of various dates relating to completion of the selected transaction process.

In yet another embodiment, a method of creating template documents for use in an electronic system for facilitating the completion of a complex transaction in a particular business sector and/or jurisdiction selected from a plurality of available business sectors and/or jurisdictions comprises the steps of: identifying required documents for the completion of a complex transaction for each of the available business sectors and/or jurisdictions; creating an electronic version of each required document in each available business sector and/or jurisdiction; incorporating at least one dynamic field in at least one electronic version of the required documents in each available business sector and/or jurisdiction (i.e., the electronic version of at least one document from all of the required documents); and, producing the electronic version of each required document for a selected business sector and/or jurisdiction of the available business sectors and/or jurisdictions for electronic access by a user. The dynamic field allows for inputting information specific to a particular transaction into the electronic version of the document. Accordingly, many or all of the electronic versions of the required documents may need to incorporate one or more dynamic fields to allow a user to later customize the documents for completing a transaction.

The identifying required documents for each of the available business sectors and/or jurisdictions may include receiving advise about the required documents from a plurality of professionals knowledgeable about the complex transaction wherein each professional is familiar with some or all of the required documents in at least one of the available business sectors and/or jurisdictions. In one example, the professionals may be a network of real estate attorneys (in a plurality of different available jurisdictions, e.g., States) that assist in identifying the closing documents for a real estate transaction in the various available jurisdictions.

The professionals can also verify the accuracy of an electronic version of the required documents associated with one of the available business sectors and/or jurisdictions.

Another embodiment for creating template documents for use in an electronic system for facilitating the completion of a complex transaction comprises the steps of: identifying required documents for the completion of a complex transaction; creating an electronic version of each required document; incorporating at least one dynamic field in at least one electronic version of the required documents; and, producing the electronic version of each required document for electronic access by a user.

When the transaction process can be performed in different business sectors and/or jurisdictions, the method would then further comprise identifying a plurality of available business sectors and/or jurisdictions for facilitating the completion of the complex transaction. In this case, the required documents would be broken into sets of required documents for each business sector and/or jurisdiction, and the method would include identifying a plurality of subsets of required documents, each subset of required documents for one of the plurality of available business sectors and/or jurisdictions. The identifying a plurality of subsets of required documents step may include receiving advise about each of the subsets of required documents from a plurality of professionals knowledgeable about the complex transaction, each professional familiar with the required documents in at least one of the available business sectors and/or jurisdictions.

In yet another embodiment of the invention, a method for computerized completion of a complex transaction comprises the steps of: providing at least one server computer in communication with a computer network; receiving input by the server computer containing information relevant to a transaction process; and, incorporating the inputted information into required documents for the transaction process. The method may further include electronically storing the required documents for the transaction process in a database, and also electronically storing the information relevant to the transaction process in a database. The documents can then be accessed at a later time.

Additionally, the method may comprise providing access by the server computer to a plurality of sets of required documents for a corresponding plurality of transaction processes. In this case the method may comprise receiving input by the server computer selecting one of the sets of required documents, wherein the selected set of required documents from the plurality of sets of required documents is utilized for performing the step of incorporating the inputted information into required documents for the transaction. Moreover, each of the sets of required documents may correspond to a transaction process in a particular business sector and/or jurisdiction, and the selecting step may comprise receiving input by the server computer identifying one of the business sectors and/or jurisdictions.

Each of the above methods or systems may include log-on procedures for providing full or limited access to a user, and may also allow for saving the completed documents for later use by the user or possibly a different user.

Further aspects of the invention are disclosed in the detailed description of the preferred embodiment, the drawings and the claims.

### BRIEF DESCRIPTION OF THE DRAWINGS

FIG. 1 is a transaction flow chart for a system in accordance with the present invention.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention relates to a method for enabling the: (a) creation, testing, development and production of dynamic documentation customized for particular business sectors and/or jurisdictions, including, without limitation, using a nationwide professional network, (b) end-user identification, verification, contact management and process management and (c) efficient input, storage, accessibility, flow and incorporation of content in a computer network based and proprietary schema-driven matrix, all of the foregoing enabling an end-user to select, review and finalize certain processes in any business sector and/or jurisdiction nationwide.

In accordance with the present invention, an end-user would access a networked computer system initially through a sign-up process enabling a manifestation of assent for terms of use or other contractual requirements and thereafter using idiosyncratic identifying information, including, without limitation, a log-in name and password. The system would verify the manifestation of assent and identifying information through a back-end database function. If the end-user information is not verified, the system would return the end-user to the position where the end-user could attempt re-submittal of the identifying information. If the end-user information is verified properly, a menu would be displayed that would enable the end-user to access several process management areas based upon the system level role of the end-user. The menu would display areas for contact management, process ordering and tracking, calendaring or other date/time sensitive matter management, and other process management areas wherein the end-user could review processes already started or completed, continue unfinished processes or begin a new process.

If beginning a new process, the end-user would: (a) identify the particular entit(ies) or individual(s) to which the process would apply in conjunction with or in addition to the contact management area (“Selected Client”), (b) select a particular business sector and/or jurisdiction (“Selected Sector/Jurisdiction”) and (c) select one of the processes available within the Selected Sector/Jurisdiction (“Selected Process”). The system would accommodate the end-user with respect to the selection and submittal of relevant content for the Selected Client on an individual basis or in a batch process through various means depending upon the level of technical capability of the end-user, including, without limitation, an intake form or a format corresponding with or convertible to a proprietary schema utilizing Extensible Markup Language (“XML”) or other dynamic configuration. The end-user would submit the relevant content into the system through electronic means (including, without limitation, electronic mail, system posting or other electronic transfer functionality) in the designated format (“Submitted Content”).

The system would then render various checks against the Submitted Content in order to identify any errors or missing information required for the Selected Process. If any required information was missing or any errors arose, the system would automatically complete content previously submitted and contained within the system. Additionally, the system would notify the end-user and allow the end-user to review the automatically completed functionality, correct any errors or enter any missing information. The verification process would continue until the Submitted Content satisfies the requirements of the Selected Process or the end-user indicates that certain dependent requirements will be completed outside of the system.

Upon the verification of the Submitted Content, the system would identify the required documents and processes, including, without limitation, any dependent documents and tasks not otherwise selected by the end-user that are required to finalize the Selected Process in the Selected Sector/Jurisdiction (“Required Documents”).

As each business sector/jurisdiction may differ with respect to the requisite documents and tasks necessary for any particular process, all Required Documents are: (a) identified using a nationwide network of professionals, (b) modified or created in a manner that would incorporate dynamic, proprietary fields and requirements corresponding with the proprietary schema, along with verification and real time help, (c) tested internally and confirmed by the nationwide professional network and (d) produced for end-user accessibility and use. In this manner, each Required Document would incorporate and be customizable to the Submitted Content, Selected Sector/Jurisdiction and Selected Process.

The system would characterize and map the Submitted Content to the corresponding proprietary fields in the Required Documents prepared and organized for the Selected Sector/Jurisdiction and the Selected Process. Promptly after incorporating the Submitted Content into the Required Documents, the system would deliver through electronic means (including, without limitation, electronic mail, system posting or other electronic transfer functionality) a set of non-editable customized documents to the end-user for review and finalization (“Customized Documents”), along with any notifications or disclaimers with respect to use of and outstanding tasks associated with the Customized Documents.

If the end-user wanted to modify the Submitted Content incorporated within the Customized Documents, the end-user could submit revised Submitted Content through a designated means, enabling the document verification, customization and delivery process to repeat. The Required Documents could only be revised through a directed and verified process utilizing the nationwide network of professionals within the industry in the specific business sector and/or jurisdiction.

If the end-user was satisfied with the Customized Documents, the end-user could download, print or coordinate efforts to otherwise finalize the Selected Process. The system would enable the end-user to coordinate, track or otherwise manage the finalization of the Selected Process through other process management functions within the system, including, without limitation, a calendaring function for identifying and notifying critical dates and times relative to the Selected Process, an ordering and tracking function to finalize a Selected Process through an affiliated entity and an invoicing and payment function with respect otherwise ordered products or services.

The Submitted Content, including, without limitation, the Selected Process and the Selected Sector/Jurisdiction would then be saved within the system for use by the end-user for future processes. As such, the time to enter and submit content for future processes by the end-user is significantly minimized, saving a significant amount of time and expense. The end-user would then be able to review prior processes, complete an unfinished process or begin a new process.

### Real Estate Transaction Process:

An example of one use of a system in accordance with the present invention is for real estate transactions, such as the purchase of a new home or condominium. This may include, for example (either as a complete transaction process or as part of a larger transaction process), generating or otherwise creating a deed (e-g., a warranty deed, a quit claim deed, or a grant, bargain and sale deed etc.). Each business sector and/or jurisdiction typically requires a particular set of documents to complete the transaction process as well as the performance of various tasks or procedures, all of which are (or may be) unique to that business sector and/or jurisdiction. The system allows a user to select the particular business sector and/or jurisdiction at issue and provides the user with, and helps complete, the appropriate documents for closing the transaction in the selected business sector and/or jurisdiction. The system also notifies the user of the various tasks or procedures that need to be completed. The system is preferably accessed via the world wide web. However, the system can be placed on other networks, or on a single computer system.

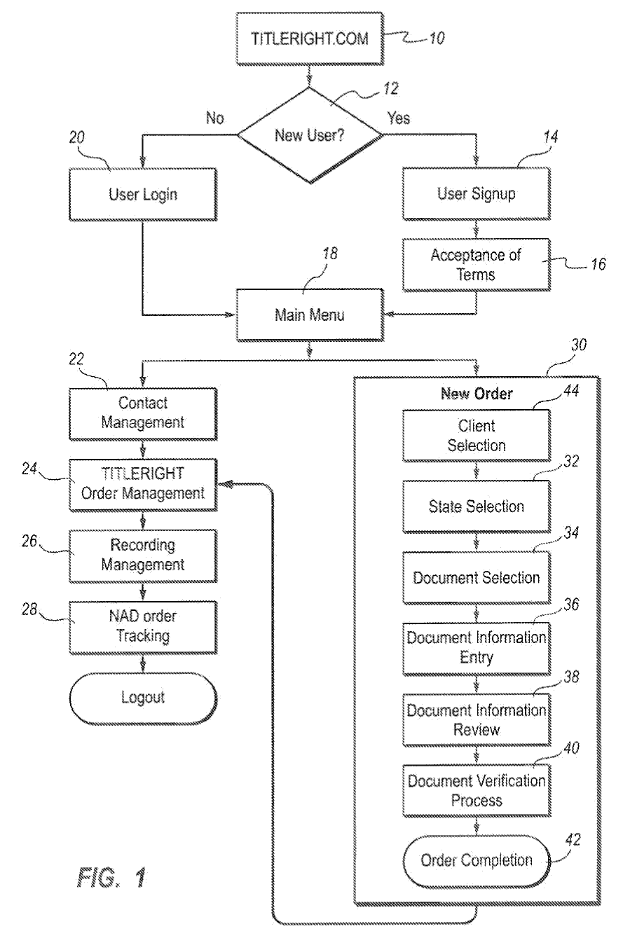

Referring to the example in FIG. 1, a user would connect via a computer to a web site 10 for completing real estate transactions (called “TitleRight.com” in the Figure). The web site is hosted by at least one server computer having an interface for communicating with the network. The server computer may be linked to and operate in conjunction with other servers or devices. Preferably the user will use a browser, such as Microsoft Internet Explorer, and will have access to Adobe Acrobat Reader (to enable the user to read the completed documents).

The site may prompt 12 the user to identify whether the user is new, or has previously signed up at the site 10. If the user is new, the user is directed to a sign up area 14 (this may be a separate page linked to the home page of the web site in a conventional manner). The sign up process may require obtaining certain information from the user. Once the user is signed up, the user is prompted 16 to review the terms of using the site, and can indicate acceptance of the terms. The user is then directed to a main menu 18. If the user has previously signed up, the user can log in 20 and then proceed to the main menu 18.

From the main menu, the user can either review the status or modify the management of a prior order 22,24,26,28, or proceed with a new order 30. When proceeding with a new order, the user will be prompted 32 to select a business sector and/or jurisdiction (in this case a state) for the transaction. The web site will then identify 34 the documents required for completing the real estate transaction process in the selected state (which are obtained as described above), and will interactively gather 36 relevant information from the user to complete the documents. The user can review the documents for accuracy 38, and provide revised information or otherwise edit the documents if necessary. The documents are verified 40 by the web site, and the order is completed 42. Upon completion, the user is linked to the order status management portion of the site. The user can order the documents prepared (pricing may depend on the complexity of the transaction process and/or the number of documents requested) which can then be electronically delivered or posted for the user's use. The web site can also provide a calendar of dates of events that relate to the transaction, and may provide electronic notification of such events prior to such dates. Further, the site can also provide the user with information concerning various other tasks or procedures that must be accomplished to complete the transaction (e-g., recording title to the property, etc.)

The host server for the site 10 can maintain the required documents for each of the business sectors and/or jurisdictions in a resident database. Alternatively, the host server can be linked to other computers having all or part of such a database.

The site 10 may also provide the ability to create a new client each time a user is logged on to the site 10. In this case, the user can select 44 the client from a list.

Conventional program code and web site design can be used to implement the unique functionality described herein with respect to the invention.

While specific embodiments have been illustrated and described, numerous modifications are possible without departing from the spirit of the invention, and the scope of protection is only limited by the scope of the accompanying claims.

1. A method for online completion of documents associated with a complex transaction comprising the steps of:
providing at least one server computer in communication with a computer network;
generating output from the server computer identifying at least one transaction process available, said transaction process including a plurality of required documents for completion of the transaction;
receiving input by the server computer;
selecting by the server computer a particular transaction process based on the received input for use in the transaction;
automatically identifying by the server computer the plurality of required documents for completion of the transaction; and,
receiving input by the server computer comprising information relevant to the plurality of required documents to the particular transaction process whereby the plurality of required documents are automatically updated with the information.

2. The method of claim 1 further comprising the steps of generating output by the server computer identifying a plurality of jurisdictions for the transaction; and,
receiving input by the server computer identifying a particular jurisdiction for the transaction.

3. The method of claim 2 further comprising the step of generating output from the server computer identifying a plurality of transaction processes available for the particular jurisdiction wherein said particular transaction process is from said identified plurality of transaction processes.

4. The method of claim 1 further comprising the step of determining by the server computer if the information relevant to the plurality of required documents to the particular transaction process is sufficient to complete the plurality of required documents.

5. The method of claim 4 further comprising the step of generating output from the server computer identifying missing information required for the particular transaction process.

6. The method of claim 1 further comprising the step of generating output from the server computer identifying the required documents for completing the transaction.

7. The method of claim 1 further comprising the step of electronically delivering from the server computer to a user the required documents incorporating the information relevant to the particular transaction process.

8. The method of claim 3 further comprising the step of generating output from the server computer identifying tasks required to complete the transaction in the identified jurisdiction.

9. The method of claim 2 wherein said transaction process is a real estate transaction and the method further comprises generating output from the server computer identifying required documents in the identified particular jurisdiction for closing the real estate transaction.

10. The method of claim 7 further comprising the steps of:
receiving input by the server computer of revised information relevant to the particular transaction process;
incorporating the revised information relevant to the particular transaction process into the required documents; and,
electronically delivering from the server computer to the user the required documents incorporating the revised information relevant to the particular transaction process.

11. The method of claim 3 further comprising the steps of:
providing a database linked to the server computer maintaining a plurality of required documents for each transaction process for each jurisdiction.

12. The method of claim 7 further comprising the steps of:
calendaring dates by the server computer of events necessary for the completion of the particular transaction process; and,
generating output from the server computer electronically notifying a user of the dates of the events prior to the dates of the events.

13. The method of claim 7 further comprising the steps of:
receiving input by the server computer relating to completion of a step of the particular transaction process, and,
tracking by the server computer of the status of the particular transaction process.

14. The method of claim 1 further comprising the step of:
receiving input by the server computer identifying a: plurality of entities involved in the transaction.

15. A system for online completion of a complex transaction comprising:
at least one server computer having an interface for communication over a computer network;
the server computer configured to generate information through the interface identifying at least one transaction process available;
the server computer configured to receive information through the interface and select a particular transaction process based on the received information for use in the transaction;
the server computer configured to automatically identify a plurality of required documents for completion of the particular transaction process; and,
the server computer configured to receive information relevant to the plurality of required documents to the particular transaction through the interface whereby the server computer is configured to automatically update the required documents with the information.

16. The system of claim 15 wherein the server computer is further configured to receive information through the interface identifying a jurisdiction for the transaction.

17. The system of claim 15 wherein the server computer is further configured to generate information through the interface identifying a plurality of transaction processes available for the identified jurisdiction.

18. The system of claim 15 wherein the server computer is further configured to determine if the received information relevant to the plurality of required documents to the particular transaction process is sufficient to complete the plurality of required documents.

19. The system of claim 18 wherein the server computer is further configured to generate information identifying missing information required to complete the plurality of required documents for the particular transaction process.

20. The system of claim 15 wherein the server computer is further configured to deliver through the interface to a user the plurality of required documents incorporating the information relevant to the particular transaction process.

21. The system of claim 20 wherein the server computer is further configured to generate information identifying tasks related to completing the transaction.

22. The system of claim 20 wherein the server computer is further configured to receive input of revised information relevant to the particular transaction process;
incorporate the revised information relevant to the particular transaction process into the plurality of required documents; and,
electronically deliver to the user the plurality of required documents incorporating the revised information relevant to the particular transaction process.

23. The system of claim 17 further comprising a database linked to the server computer, the database including the plurality of required documents for each transaction process for each jurisdiction.

24. The system of claim 15 further comprising the server computer configured to receive information through the interface identifying a plurality of entities involved in the transaction.

25. The system of claim 15 wherein said transaction is a real estate transaction.

26. A computer program product for use with a computer, said program product comprising:
a computer usable medium having computer readable program code embodied therein, the program including:
a first portion for receiving information identifying entities involved in a transaction;
a second portion for generating information identifying at least one transaction process available for the transaction;
a third portion for automatically identifying a plurality of required documents for completion of the transaction;
a fourth portion for receiving information selecting a particular transaction process for use in the transaction;
a fifth portion for receiving information relevant to the plurality of required documents to the particular transaction process; and,
a sixth portion for automatically updating the plurality of required documents with the information.

27. The computer program product of claim 26 further comprising a seventh portion for receiving information identifying a jurisdiction for the transaction.

28. The computer program product of claim 27 wherein the seventh portion is further configured to identify a plurality of transaction processes available for the identified jurisdiction.

29. The computer program product of claim 27 wherein the seventh portion is further configured to determine if the received information relevant to the particular transaction process is sufficient.

30. The computer program product of claim 29 further comprising an eighth portion for identifying missing information required for the particular transaction process.

31. The computer program product of claim 30 wherein the eighth portion is further configured to identify the plurality of required documents maintained in a database for completing the transaction in the identified jurisdiction.

32. The computer program product of claim 31 further comprising a ninth portion for incorporating the information relevant to the particular transaction process into the plurality of required documents.

33. The computer program product of claim 32 further comprising a tenth portion for electronically delivering to a user the plurality of required documents incorporating the information relevant to the particular transaction process.

34. The computer program product of claim 33 wherein the tenth portion is further configured to calendar dates of events necessary for the completion of the particular transaction process; and,
an eleventh portion for notifying a user of the dates of the events prior to the dates of the events.

35. The computer program product of claim 34 further comprising a twelfth portion for tracking a status of the particular transaction process.

36. The method of claim 1 further comprising the step of receiving login input by the server computer and logging on a user to the server computer based on the received login input.

37. The method of claim 1 further comprising the step of saving the plurality of required documents incorporating the information relevant to the particular transaction process in a computer readable medium.

38. The system of claim 15 wherein the server computer is further configured to receive information to enable a user to log onto the system.

39. The system of claim 15 wherein the server computer is further configured to save the plurality of required documents which incorporate the information relevant to the particular transaction process on a computer readable medium.

40. The system of claim 39 wherein said computer readable medium is a memory chip located in the server computer.

41. The system of claim 39 wherein said computer readable medium is a CD.

42. The computer program product of claim 27 wherein the seventh portion is further configured to enable a user to log into the program.

43. The computer program product of claim 33 wherein the tenth portion is further configured to save the required documents incorporating the information relevant to the particular transaction process in a computer readable medium.

44. The method of claim 2 wherein said transaction process includes providing a deed and the method further comprises generating output from the server computer identifying the plurality of required documents in the identified particular jurisdiction for generating said deed.

45. The method of claim 1 further comprising the steps of
generating output by the server computer identifying a plurality of business sectors for the transaction; and,
receiving input by the server computer identifying a particular business sector for the transaction.

46. The system of claim 15 wherein the server computer is further configured to receive information through the interface identifying a business sector for the transaction.

47. The computer program product of claim 27 wherein the seventh portion is further configured to receive information identifying a business sector for the transaction.
